(19) United States
(12) Patent Application Publication
(10) Pub. No.: US 2025/0340769 A1
(43) Pub. Date: Nov. 6, 2025

(54) DUST SUPPRESSION MATERIAL WITH DUAL NETWORK REINFORCED STRUCTURE AND ITS PREPARATION METHOD

(71) Applicant: SHANDONG UNIVERSITY OF SCIENCE AND TECHNOLOGY, Qingdao (CN)

(72) Inventors: Haiming YU, Qingdao (CN); Yao XIE, Qingdao (CN); Han YUN, Qingdao (CN); Wang LI, Qingdao (CN); Huitian PENG, Qingdao (CN); Qiang LIU, Qingdao (CN)

(21) Appl. No.: 19/040,424

(22) Filed: Jan. 29, 2025

(30) Foreign Application Priority Data
May 6, 2024 (CN) 202410550509.7

(51) Int. Cl. C09K 3/22; C08K 3/16; C08K 5/053; C08K 5/07; C08K 5/42

(52) U.S. Cl. CPC C09K 3/22; C08K 3/16; C08K 5/053; C08K 5/07; C08K 5/42

(57) ABSTRACT

A dust suppression material with dual network reinforced structure and its preparation method is provided, which relates to the field of dust control technology. The material comprises by weight: 0.1-0.5 parts of sesbania gum, 0.1-0.9 parts of polyacrylamide, 0.1-0.5 parts of carboxymethyl cellulose, 0.06-0.14 parts of crosslinking agent, 0.11-0.19 parts of oxidant, 0.1-0.3 parts of water retaining agent, 0.2-1 parts of wetting agent, and the balance is distilled water. The dust suppressant with dual network reinforced structure produced by the present disclosure can effectively improve the hydrophilicity and adhesion of dust, form a dense protective film on the surface of dust, meet the requirements of dust suppressant adhesion and wettability for underground coal mining operations and outdoor coal storage filed, and will not cause secondary pollution to the environment.

### CROSS-REFERENCE TO RELATED APPLICATIONS

This application claims priority to Chinese Application No. 202410550509.7, filed on May 6, 2024, entitled “A DUST SUPPRESSION MATERIAL WITH DUAL NETWORK REINFORCED STRUCTURE AND ITS PREPARATION METHOD”. These contents are hereby incorporated by reference.

### TECHNICAL FIELD

The present disclosure relates to the field of dust control technology, particularly to a dust suppression material with dual network reinforced structure and its preparation method.

### BACKGROUND

A large amount of coal dust will be generated during coal production, storage, and transportation, not only resulting in a serious pollution to the environment, but also threatening the equipment safety and the human health. Based on the monitoring data regarding the latest environmental pollution, the dust emissions and pollution have caused serious exceedance of PM_{2.5} and PM₁₀ in the environment. In addition, coal dust can increase the wear and tear of equipment parts, leading to reduced equipment accuracy or failure, and even casualties. According to the incomplete statistics, the number of pneumoconiosis patients in the coal industry of China accounts for 58% of the total number of occupational pneumoconiosis patients, with a mortality rate of 22.04%, which is far higher than the safety accidents. Coal dust is the main factor restricting coal mine safety production, and the coal dust pollution has become an urgent problem to be solved in the industry.

Currently, the chemical dust suppressants have received widespread attention in the coal dust control due to their good dust suppression effects. The dust suppressants have ranged from single type to composite and specialized types. Traditional dust suppressants of single type include wetting, bonding, and moisture absorbing types, while composite dust suppressants have multiple functions of wetting, bonding, and solidification. However, they have shortcomings such as weak mechanical properties, difficult degradation, and susceptibility to secondary pollution.

Therefore, it is necessary to produce an economical and environmentally friendly composite dust suppression material.

### SUMMARY

To solve the technical problem of single function and difficult degradation of the traditional chemical dust suppressants, a dust suppressant material with dual network reinforced structure and its preparation method is provided, comprising the following technical solution:

In a first aspect, a dust suppression material with dual network reinforced structure is provided, comprising:
sesbania gum, polyacrylamide, carboxymethyl cellulose, crosslinking agent, oxidant, water retaining agent, wetting agent, and distilled water.

Preferably, a dust suppression material with dual network reinforced structure, comprising by weight:
0.1-0.5 parts of sesbania gum,
0.1-0.9 parts of polyacrylamide,
0.1-0.5 parts of carboxymethyl cellulose,
0.06-0.14 parts of crosslinking agent,
0.11-0.19 parts of oxidant,
0.1-0.3 parts of water retaining agent,
0.2-1 part of wetting agent.

Sesbania gum is an environmentally friendly natural polysaccharide, and its galactomannan is a long-chain polymer containing a large number of hydroxyl groups. It has a high affinity for water, a certain degree of viscosity and cross-linking property, good biocompatibility, and is easily chemically modified.

Polyacrylamide is a linear polymer with non-toxic and stable properties. Its structural units contain amide groups and are prone to hydrogen bonding. It has good water solubility and high chemical activity, and can be easily modified into a network structure through grafting or cross-linking.

Carboxymethyl cellulose has high solubility and stability. Due to its unique surface properties, mechanical strength, and good adhesion, it can be used as a reinforcing agent for dust suppression materials.

Preferably, the crosslinking agent is glutaraldehyde, which is one of the most commonly used crosslinking agents and has the characteristics of high reactivity, short crosslinking time, and stable product.

Preferably, the oxidant is sodium periodate.

Preferably, the water retaining agent is glycerol, which serves as an auxiliary material for water retention and can prevent the curing film from drying and cracking.

Preferably, the wetting agent is sodium dodecyl sulfate, which has good wetting properties, strong permeability, stability in a wide pH range, fast biodegradability, and is a non-toxic anionic surfactant.

In a second aspect, a method for preparing the dust suppression material is provided, comprising the following steps:
(1) adding the distilled water and the sesbania gum to a beaker, stirring and dissolving the sesbania gum, adjusting pH of the solution with a dilute hydrochloric acid, then adding the crosslinking agent, heating to 50° C. and reacting for 1.5 hours to obtain a mixture I;
(2) adding the oxidant to the mixture I, adjusting the solution to 40° C., heating in a water bath for 1 hour, adjusting the pH of the solution to 6-7, to obtain a mixture II;
(3) adding the polyacrylamide to the mixture II, mixing and heating to react for 20 minutes, adding the carboxymethyl cellulose, and heating again in a water bath to obtain a mixture III;
(4) cooling the mixture III to room temperature, adding the wetting agent and the water retaining agent to the mixture III, to prepare a dust suppressant solution with dual network reinforced structure.

Preferably, the crosslinking agent is glutaraldehyde, the oxidant is sodium periodate, the water retaining agent is glycerol, and the wetting agent is sodium dodecyl sulfate.

The reaction of the present disclosure is as follows:

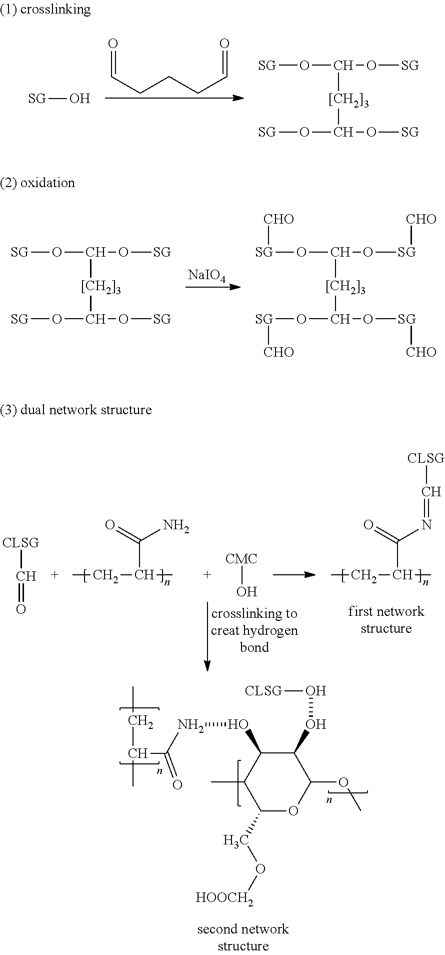

The sesbania gum is represented by SG-OH, which contains multiple hydroxyl groups on its molecular chain. The crosslinking site occurs on the adjacent cis-hydroxyl groups. The oxidation crosslinked sesbania gum is represented by CLSG-CHO, and the oxidation generally occurs on C2 and C3 hydroxyl groups. Therefore, in the product of step (3), CLSG-OH is present, and CMC-OH represents carboxymethyl cellulose.

The reaction principle is as follows:

(1) The hydroxyl groups on the main chain molecules of the sesbania gum undergo etherification crosslinking reaction with the aldehyde groups in glutaraldehyde molecules, and the newly generated chemical bonds continuously replace the original hydrogen bonds on the original molecular chain, forming a tightly cross-linked network structure.

(2) The crosslinked sesbania gum is further oxidized by sodium periodate, which converts some of the active hydroxyl groups in the crosslinked sesbania gum molecules into aldehyde groups. Simultaneously, the oxidation reaction causes the breakage of the glycosidic chain, resulting in partial degradation of the sesbania gum molecules.

(3) The oxidized aldehyde group reacts with the amino group of polyacrylamide, and the hydrogen bond formed by the amino group of polyacrylamide and the hydroxyl group of sesbania gum strengthens the intermolecular forces. Linear polyacrylamide is interspersed to form an interpenetrating network, forming the first network structure.

(4) The molecular chains of sesbania gum intertwine with each other as a skeleton, and the oxidized cross-linked sesbania gum forms an interpenetrating network structure with polyacrylamide. After adding carboxymethyl cellulose, it crosslinks with polyacrylamide and is connected by hydrogen bonding adsorption, which enhances the original network and forms a second network structure.

The beneficial effects of the invention are as follows:

1. The present invention uses a composite modification method to modify sesbania gum The aldehyde group in glutaraldehyde molecules undergoes etherification crosslinking reaction with the adjacent cis-hydroxyl group on sesbania gum molecules. The newly generated chemical bonds continuously replace the hydrogen bonds on the original molecular chain, and the crosslinking structure increases the strength and cohesion of sesbania gum. Crosslinked sesbania gum is oxidized by sodium periodate, further oxidizing some of the active hydroxyl groups in the crosslinked sesbania gum molecules into aldehyde groups. At the same time, the oxidation reaction causes the glycosidic chain to break, reducing the viscosity of sesbania gum and improving its fluidity. The oxidized sesbania gum is cross-linked, entangled, and interlaced with polyacrylamide and carboxymethyl cellulose to form a double network structure. Then, sodium dodecyl sulfate is compounded to enhance the wetting performance, ultimately resulting in an environmentally friendly and tightly structured dust suppression material.

2. After the dust suppressant produced by the present disclosure is sprayed on the coal dust, the wetting agent sodium dodecylbenzenesulfonate molecules can weaken the intermolecular forces, thereby reducing the surface tension, allowing the dust suppressant to better penetrate and fill the gaps between the dust particles, enhancing the hydrophilicity and wetting effect of the dust particles. The oxidized cross-linked sesbania gum-polyacrylamide molecules in the dust suppressant contain a large number of hydrophilic groups, which can bind the coal dust particles together through bonding. The added carboxymethyl cellulose enhances the rigidity of the network structure due to hydrogen bonding, forming a hard solidified layer. The double cross-linked network structure also improves the agglomeration effect between the coal dust particles, enhances their ability to resist external forces, and makes them less susceptible to wind flow. The added glycerol can retain a certain amount of moisture in the solidified layer, prevent cracking, further enhance the anti-interference ability of the solidified layer, and greatly slow down the continued evaporation of moisture, prolonging the dust suppression time.

3. The dust suppressant with dual network reinforced structure produced by the present disclosure can effectively improve the hydrophilicity and adhesion of dust, and can form a dense protective film on the surface of dust. It has been shown that the dust suppressant produced by the present disclosure has a water retention rate 36.0% higher than water, and a dust suppression rate of 98.67% for PM₁₀ by testing. It has high dust suppression efficiency, high permeability, and high crust strength, meeting the requirements for the adhesion and wettability of the dust suppressants in underground coal mining operations and outdoor coal storage field, while not causing secondary pollution to the environment.

### BRIEF DESCRIPTION OF THE DRAWINGS

FIG. 1 is a process flowchart of a method for preparing a dust suppression material with dual network reinforced structure according to the present disclosure.

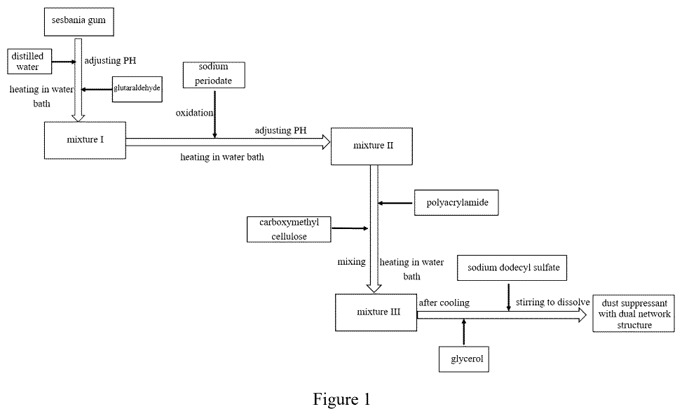

### DETAILED DESCRIPTION OF THE EMBODIMENTS

The present invention will be further described with reference to the drawings and preferred embodiments. It should be understood that these embodiments are only used to illustrate the present invention, but the present invention is not limited thereto. In addition, it should be understood that after reading the content described in the present invention, those skilled in the art can make various changes or modifications to the present invention, and these equivalent technical means also fall within the scope of protection of the present invention.

The present disclosure discloses a dust suppression material with dual network reinforced structure and its preparation method. The raw materials used include 0.1-0.5 parts of sesbania gum, 0.1-0.9 parts of polyacrylamide, 0.1-0.5 parts of carboxymethyl cellulose, 0.06-0.14 parts of crosslinking agent, 0.11-0.19 parts of oxidant, 0.1-0.3 parts of water retaining agent, 0.6-1 parts of wetting agent, and the balance is distilled water.

### Embodiment 1

(1) Adding 100 ml of distilled water and 0.1 g of sesbania gum to a beaker, stirring to dissolve, adjusting the pH of the solution to 4 with a dilute hydrochloric acid, then slowly adding 0.06 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.1 g of polyacrylamide to the mixed solution II, mixing thoroughly, heating to 50° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 2

(1) Adding 100 ml of distilled water and 0.1 g of sesbania gum to a beaker, stirring to dissolve, adjusting the pH of the solution to 4 with a dilute hydrochloric acid, then slowly adding 0.1 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.9 g of polyacrylamide to the mixed solution II, mixing thoroughly, heating to 60° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 3

(1) Adding 100 ml of distilled water and 0.1 g of sesbania gum to a beaker, stirring to dissolve, adjusting the pH of the solution to 4 with a dilute hydrochloric acid, then slowly adding 0.14 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.5 g of polyacrylamide to the mixed solution II, mixing thoroughly, heating to 70° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 4

(1) Adding 100 ml of distilled water and 0.3 g of sesbania gum to a beaker, stirring to dissolve, adjusting the pH of the solution to 4 with a dilute hydrochloric acid, then slowly adding 0.06 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.9 g of polyacrylamide to the mixed solution II, mixing thoroughly, heating to 70° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 5

(1) Adding 100 ml of distilled water and 0.3 g of sesbania gum to a beaker, stirring to dissolve, adjusting the pH of the solution to 4 with a dilute hydrochloric acid, then slowly adding 0.1 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.5 g of polyacrylamide to the mixed solution II, mixing thoroughly, heating to 50° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 6

(1) Adding 100 ml of distilled water and 0.3 g of sesbania gum to a beaker, stirring to dissolve, adjusting the pH of the solution to 4 with a dilute hydrochloric acid, then slowly adding 0.14 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.1 g of polyacrylamide to the mixed solution II, mixing thoroughly, heating to 60° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 7

(1) Adding 100 ml of distilled water and 0.5 g of sesbania gum to a beaker, stirring to dissolve, adjusting the pH of the solution to 4 with a dilute hydrochloric acid, then slowly adding 0.06 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.5 g of polyacrylamide to the mixed solution II, mixing thoroughly, heating to 60° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 8

(1) Adding 100 ml of distilled water and 0.5 g of sesbania gum to a beaker, stirring to dissolve, adjusting the pH of the solution to 4 with a dilute hydrochloric acid, then slowly adding 0.1 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.1 g of polyacrylamide to the mixed solution II, mixing thoroughly, heating to 70° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Embodiment 9

(1) Adding 100 ml of distilled water and 0.5 g of sesbania gum to a beaker, stirring to dissolve, adjusting the pH of the solution to 4 with a dilute hydrochloric acid, then slowly adding 0.14 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, to obtain a mixture II;
(3) Adding 0.9 g of polyacrylamide to the mixed solution II, mixing thoroughly, heating to 50° C. and reacting for 20 minutes, adding 0.2 g of carboxymethyl cellulose and heating again in a water bath for 30 minutes to obtain a mixed solution III;
(4) Cooling the mixture III to room temperature, adding 0.8 g of sodium dodecyl sulfate and 0.2 g of glycerol to the mixture III, mixing thoroughly, to obtain a dust suppressant solution with dual network reinforced structure.

### Comparative Example 1

(1) Adding 100 ml of distilled water and 0.3 g of sesbania gum to a beaker, stirring to dissolve, adjusting the pH of the solution to 4 with a dilute hydrochloric acid, then slowly adding 0.06 g of glutaraldehyde, heating to 50° C., and reacting for 1.5 hours to obtain a mixture I;
(2) Adding 0.15 g of sodium periodate to the mixture I, adjusting the solution to 40° C., heating in a water bath for 1 hour, adjusting the pH of the solution to 6-7, cooling the solution to room temperature, adding 0.8 g of sodium dodecyl sulfate and 0.2 g of glycerol, and mixing thoroughly.

### Comparative Example 2

(1) Adding 100 ml of distilled water to a beaker, followed by 0.8 g of sodium dodecyl sulfate and 0.2 g of glycerol, and stirring to dissolve.

The effectiveness of examples 1-9 and comparative examples 1 and 2 is evaluated through testing. The following experiments are conducted in accordance with the TB/T3210.1-2020 standard for coal sample preparation, using a standard sieve to screen 200 mesh coal samples. The coal samples are dried in a drying oven at (50±2) ° C. for 5 hours to remove moisture, then it is taken out and left at room temperature for 1 hour.

### Test 1

The dust suppression performance of the dust suppressants with dual network reinforced structure prepared in Examples 1-9 and Comparative Examples 1 and 2 will be tested.

Testing method: Putting equal amounts of coal powder in multiple identical culture dishes, scattering for 10 minutes at a wind speed of 12 m/s, and then naturally settling the dust for 2 minutes; Using a handheld laser particle counter (9306-V2) to detect the concentrations of PM_{2.5} and PM₁₀, and recording them as C₀; Spraying Examples 1-9 and Comparative Examples 1 and 2 evenly and equally into the culture dish; After 48 hours, scattering at a wind speed of 12 m/s for 10 minutes; After 2 minutes, measuring the concentrations of PM_{2.5} and PM₁₀ and recording them as C₁.

The formula for calculating dust suppression rate is:

$$S = \frac{{C}_{0} - {C}_{1}}{{c}_{0}} \times 100 \%$$

Wherein, S is the dust suppression rate (%), C₀ is the initial concentration of PM_{2.5} and PM₁₀ (μg/m³), C₁ is the concentration of PM_{2.5} and PM₁₀ after spraying dust suppressants (μg/m³). When calculating C₀ and C₁, the concentration of PM_{2.5} and PM₁₀ present in the initial ambient air needs to be subtracted.

The test results are shown in Table 1 below.

TABLE 1
Dust suppression test

| Test samples | PM_{2.5} | PM₁₀ |
|---|---|---|
| Example 1 | 96.34 | 97.21 |
| Example 2 | 97.08 | 97.54 |
| Example 3 | 98.03 | 98.21 |
| Example 4 | 97.25 | 97.57 |
| Example 5 | 97.31 | 97.64 |
| Example 6 | 97.69 | 98.17 |
| Example 7 | 98.04 | 98.67 |
| Example 8 | 98.18 | 98.34 |
| Example 9 | 97.77 | 98.51 |
| Comparative example 1 | 79.23 | 78.12 |
| Comparative example 2 | 50.19 | 53.67 |

It is found that the test solution reduces the concentrations of PM_{2.5} and PM₁₀, and the dust suppression effect of the comparative examples is not as significant as that of the examples after analyzing the results of Test 1. Example 7 can achieve the highest dust suppression rate (PM_{2.5} and PM₁₀ are 98.18% and 98.34%, respectively). Therefore, the above results indicate that the dust suppressant with dual network structure indeed has good dust suppression performance, greatly alleviating the static dust resuspension.

### Test 2

The dust suppressants with dual network reinforced structure prepared in Examples 1-9, as well as Comparative Examples 1 and 2, will be tested for their water retention, wettability, and permeability.

Testing method: putting the same amount of pulverized coal in several Petri dishes, laying the coal dust surface with the samples of Examples 1-9 and the Comparative examples 1-2, each of the samples having the same weight, and putting the Petri dishes in a vacuum drying oven at 50° C.; After 2 hours, taking out the samples, weighing and calculating the cumulative evaporation rate of the samples.

Taking 30 ml of the test solution into a beaker, placing the beaker under a platinum plate, then turning on the switch, adjusting the lifting platform, waiting for the platinum plate to contact the liquid surface, and recording the tension of the test surface; Finally measuring the surface tension values of each solution three times and recording the average value.

Filling equal amounts of the coal powder into multiple tubes of the same size, and then using a burette to suck in a certain amount of dust suppressant solution (3±0.5 ml); Dropping into each tube, recording the penetration depth and time with a stopwatch, and calculating the penetration rate.

The test results are shown in Table 2 below.

TABLE 2
Water retention and wettability test

| | | | | | | Surface | permeation |
|---|---|---|---|---|---|---|---|
| Test | Cumulative evaporation rate (%) | | | | | tension | rate |
| samples | 1 h | 2 h | 3 h | 4 h | 5 h | (mN/m) | (mm · s⁻¹) |
| Example1 | 22.19 | 44.74 | 60.74 | 76.49 | 84.02 | 31.12 | 0.31 |
| Example 2 | 22.37 | 44.51 | 60.93 | 77.42 | 84.57 | 30.27 | 0.31 |
| Example 3 | 23.91 | 45.35 | 62.78 | 78.10 | 85.96 | 31.75 | 0.32 |
| Example 4 | 22.23 | 44.18 | 60.37 | 76.77 | 83.42 | 32.01 | 0.30 |
| Example 5 | 22.17 | 44.13 | 59.63 | 76.35 | 84.95 | 31.41 | 0.31 |
| Example 6 | 21.74 | 42.62 | 59.07 | 75.83 | 83.14 | 31.38 | 0.29 |
| Example 7 | 22.63 | 43.67 | 60.89 | 77.21 | 84.91 | 30.50 | 0.30 |
| Example 8 | 21.87 | 42.88 | 61.19 | 75.26 | 83.66 | 31.71 | 0.31 |
| Example 9 | 21.96 | 42.94 | 60.95 | 75.74 | 84.01 | 30.26 | 0.32 |
| Comparative | 25.38 | 45.63 | 64.85 | 85.33 | 95.47 | 29.64 | 0.29 |
| example1 | | | | | | | |
| Comparative | 27.59 | 50.32 | 70.36 | 90.16 | 98.53 | 27.32 | 0.19 |
| example2 | | | | | | | |

According to the results of Test 2, Comparative Examples 1 and 2 show the fastest water loss rate, with a cumulative evaporation rate of over 95% after 5 hours of drying. In contrast, the dense solidified layer dried and formed on the surface of the coal sample after sprayed Examples 1-9 can maintain a certain amount of moisture and has good water retention performance. According to the surface tension test, there is almost no difference between Examples 1-9 and Comparative examples 1-2, indicating good wetting performance. Slow infiltration speed can lead to poor dust fixation effect, which can easily cause secondary dust. Fast infiltration speed can lead to excessive use of dust suppressants. The examples have a fast infiltration speed, which meets the needs of dust suppression.

From this, it can be seen that the present disclosure can determine the actual dust suppression effect of the dust suppression material by designing different ratios and testing the dust suppression, water retention, permeability, and wetting properties of the produced dust suppression material.

In summary, the dust suppression material with dual network reinforced structure produced by the present disclosure integrates wetting and bonding properties, and can form a dense protective film when sprayed on the surface of coal mines to prevent the flying of coal dust. It can meet the practical needs of coal dust suppression and has good social and considerable economic benefits.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A dust suppression material with dual network reinforced structure, comprising:
sesbania gum, polyacrylamide, carboxymethyl cellulose, crosslinking agent, oxidant, water retaining agent, wetting agent, and distilled water.

2. The dust suppression material with dual network reinforced structure as claimed in claim 1, wherein comprising by weight:
0.1-0.5 parts of sesbania gum,
0.1-0.9 parts of polyacrylamide,
0.1-0.5 parts of carboxymethyl cellulose,
0.06-0.14 parts of crosslinking agent,
0.11-0.19 parts of oxidant,
0.1-0.3 parts of water retaining agent,
0.2-1 part of wetting agent, and
the remaining is distilled water.

3. The dust suppression material with dual network reinforced structure as claimed in claim 2, wherein the crosslinking agent is glutaraldehyde, the oxidant is sodium periodate, the water retaining agent is glycerol, and the wetting agent is sodium dodecyl sulfate.

4. A method for preparing the dust suppression material as claimed in claim 1, comprising:
adding the distilled water and the sesbania gum to a beaker, stirring and dissolving the sesbania gum, adjusting pH of the solution with a dilute hydrochloric acid, then adding the crosslinking agent, heating to 50° C. and reacting for 1.5 hours to obtain a mixture I;
adding the oxidant to the mixture I, adjusting the solution to 40° C., heating in a water bath for 1 hour, adjusting the pH of the solution to 6-7, to obtain a mixture II;
adding the polyacrylamide to the mixture II, mixing and heating to react for 20 minutes, adding the carboxymethyl cellulose, and heating again in a water bath to obtain a mixture III;
cooling the mixture III to room temperature, adding the wetting agent and the water retaining agent to the mixture III, to prepare a dust suppressant solution with dual network reinforced structure.

5. The method for preparing the dust suppression material as claimed in claim 4, wherein the crosslinking agent is glutaraldehyde, the oxidant is sodium periodate, the water retaining agent is glycerol, and the wetting agent is sodium dodecyl sulfate.
